(19) United States
(12) Patent Application Publication
(10) Pub. No.: US 2018/0194554 A1
(43) Pub. Date: Jul. 12, 2018

(54) RECYCLING BIN WITH MECHANISM FOR COMPACTING INDIVIDUAL CONTAINERS

(71) Applicant: International Business Machines Corporation, Armonk, NY (US)

(72) Inventors: Marie S. Cole, Wappingers Falls, NY (US); Michael R. Kane, Hopewell Junction, NY (US); Suraush Q. Khambati, Wappingers Falls, NY (US); Colin E. Masterson, Rochester, MN (US); James A. O'Connor, Ulster Park, NY (US); Jacob T. Porter, Highland, NY (US)

(21) Appl. No.: 15/404,499

(22) Filed: Jan. 12, 2017

(51) Int. Cl. B65F 1/14; B65F 1/06; B30B 9/32; B30B 15/32

(52) U.S. Cl. CPC B65F 1/1405; B65F 1/06; B65F 2210/132; B30B 15/32; B65F 2210/12; B30B 9/321

(57) ABSTRACT

A fully integrated, low maintenance, manually operated beverage container compacting system featuring a free-standing, user powered, enclosed, beverage container compactor and storage receptacle. The compactor includes a self retracting puncture mechanism to release pressure due to air and liquids in sealed containers prior to their compacting. The storage system includes double trap doors with gaskets to create a sealed storage receptacle that reduces odors. A first top trap door includes a rubber gasket to prevent liquids from being expelled out of the compactor; and a bottom trap door is configured for capturing escaped liquids. The bottom trap door is actuated into an open state at an end of a crushing stroke to drop the container into the storage receptacle after captured liquids have drained into a liquid capture container for improved cleanliness. A self reset mechanism renders the system to an initial state for a next user after compacting.

### FIELD

This disclosure relates generally to recycling bins, and particularly to an improved recycling bin that includes a compactor that allows individual containers to be compacted using only the kinetic energy furnished by the user.

### BACKGROUND

Generally, the growing popularity of disposable beverage containers has driven a push for their recycling.

Existing traditional recycling bins often store disused beverage containers without being compacted, thereby wasting space. Moreover, heavily used receptacles fill quickly and often overflow.

Adding and servicing recycling receptacles increases costs to maintain as such receptacles require attention frequently, and increases transportation and energy costs due to increased iterations to service.

To ameliorate such issues, for example, the U.S. National Park Service has recently started to ban the sale of disposable water bottles due to high volumes of trash. That is, the collecting and recycling of a park's guests' waste poses an expensive challenge in remote locations. Trips to empty recycling and trash receptacles are costly.

Moreover, remote locations do not offer power for powered or automated compactors.

Issues appurtenant with such existing recycle bin designs thus includes: wasted space, e.g., of non-compacted materials; wasted energy, e.g., due to requirement of more trips to service; lack of user friendliness, e.g., existing compactor designs are independent of a receptacle, and hence exposed and potentially unsafe for operators.

Additionally, such problems of existing designs further include the lack of odor containment, i.e., traditional recycling receptacles are often not sealed.

### SUMMARY

In one aspect, the present disclosure provides a recycling bin design allowing for recycled plastic and aluminum containers to be compacted individually under manual operation, and then dropped into a receptacle after compacting without the individual handling the container thereby saving space, reducing labor and transportation requirements, and allowing for easier sorting at single stream recycling facilities.

The recycling bin design allows for a low cost, fully integrated mechanical solution that fits in the space of a standard commercial trash container, making it possible to compact materials prior to being transported to a distant compacting facility.

The recycling bin design allows manual compacting options for both plastic and aluminum and further provides sealed storage mechanism to prevent odors from escaping.

In one aspect, there is provided an apparatus for compacting and storage of containers. The apparatus comprises: a housing providing an enclosure; a compacting compartment located in the housing above the enclosure and having an opening for receiving a container to be compacted, the compacting compartment having: a first retractable hinged trap door beneath the opening and in an initial open position to receive the container into a compaction chamber, the first hinged trap door mechanically linked to a lever arm and configured in a closed position in response to the lever arm being manually manipulated during compacting in response to a lever arm compacting stroke, and the first trap door retracting to a closed position during the compacting; and a second hinged trap door in vertical alignment and beneath with the first trap door and in an initial closed position to provide a bottom surface of the compacting chamber for supporting the container received therein, the second trap door further mechanically linked to the lever arm and in the closed position while the lever arm is manually manipulated for the compacting responsive to a lever arm compacting stroke; and a first compacting element providing a fixed compacting surface of the compacting chamber; and a second compacting element having a compacting surface, the second compacting element further mechanically linked to the lever arm with a mechanical linkage configured to move the second compacting element toward the first compacting element with a compacting force for compressing the container supported in the compacting chamber against the fixed compacting element in response to the lever arm being manually manipulated for compacting.

In a further aspect, there is provided a method for compacting a container in a recycling bin having a housing including a receptacle therein to store a compacted container. The method comprises: receiving, via a deposit opening of the housing, a container to be compacted in the bin, the container dropping into a compaction chamber through a first trap door beneath the deposit opening and in an initial open position; closing the first trap door in response to a lever arm mechanically linked to the first trap door being manipulated to a position for compacting, wherein the received container is supported on a surface of a second trap door defining a bottom of a compacting chamber, the second trap door further mechanically linked to the lever arm and in a closed state while the lever arm is manually manipulated for the compacting responsive to a lever arm compacting stroke; and actuating a first compacting element having a compacting surface to move toward a second compacting element providing a fixed compacting surface of the compacting chamber with a compacting force for compressing the container supported in the compacting chamber against the fixed compacting element in response to the lever arm being manually manipulated during the compacting, the first hinged trap door being in the closed position during the lever arm compacting stroke.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 depicts a diagram of the recycling bin with mechanism for compacting individual containers according to one embodiment;

FIG. 2 depicts a cut-away view of the recycling bin and showing an exposed interior of the main housing receptacle and compactor housing;

FIGS. 3A and 3B show a more detailed exposed cut-away view of the top housing 20 and compacting mechanism 50 during a compacting;

FIG. 3C shows further detail of the trap door at the bottom of the crush chamber actuated to a released (open) state on the action of spring loaded hinge for dropping a compacted item in the receptacle;

FIG. 4 shows a detailed view of the compacting apparatus 50 located in top housing portion of the recycling bin 10 in one embodiment;

FIG. 5A shows further detail of a puncture pin mechanism 75;

FIG. 5B shows a cut-away exposed view of the puncture pin mechanism 75.

FIG. 6A shows one embodiment of the bottom or second trap door that forms the bottom surface of the chamber in which the recyclable item is received;

FIG. 6B is a cut away view of the second trap door, depicting the angled nature of the design which provides for fluid drainage

FIGS. 7A and 7B conceptually depicts the operations of both safety trap doors according to one embodiment;

FIG. 8 conceptually depicts an exposed side-view of the trap doors and safety mechanism of the receptacle 10 of FIG. 1;

FIG. 9 depicts a block diagram of a method for compacting a single beverage container;

FIG. 10 shows a manually operated recycling bin with mechanism for compacting individual containers that only requires power from user input according to a further embodiment;

FIGS. 11A and 11B depict exposed cut-away views of the top housing portion of the receptacle of FIG. 10 that depicts the compactor mechanism for recyclable item compaction according to the further embodiment;

FIG. 12 shows an exposed view of a further alternate embodiment of a manually operated beverage container compacting and storage system (recycling bin);

FIG. 13 depicts a cut-away view of top portion of the recycling bin of FIG. 12 showing in the compactor housing a compactor mechanism according to the further alternate embodiment; and

FIG. 14 conceptually shows a top portion of a container recycling receptacle housing providing a multi-rotatable drum/crank system for compacting a recyclable container according to a further embodiment.

### DETAILED DESCRIPTION

There is provided a recycling bin design comprised of an integrated, manually operated can and bottle compactor with a sealed storage bin. Benefits over existing designs include: an all in one solution isolating users from materials and contaminants; an increased storage capacity over non-compacted materials; relies on free human energy to thereby operate at a lower cost and reduced maintenance as compared to powered compactor designs; fewer trips needed for material transportation saving time and energy; provision of a self retracting puncture pin to make compacting sealed containers easy; double trap doors with gaskets to create a sealed storage receptacle that reduces odors; a mechanism to self-reset to an initial state for a next user; and a liquid capture container for improved cleanliness.

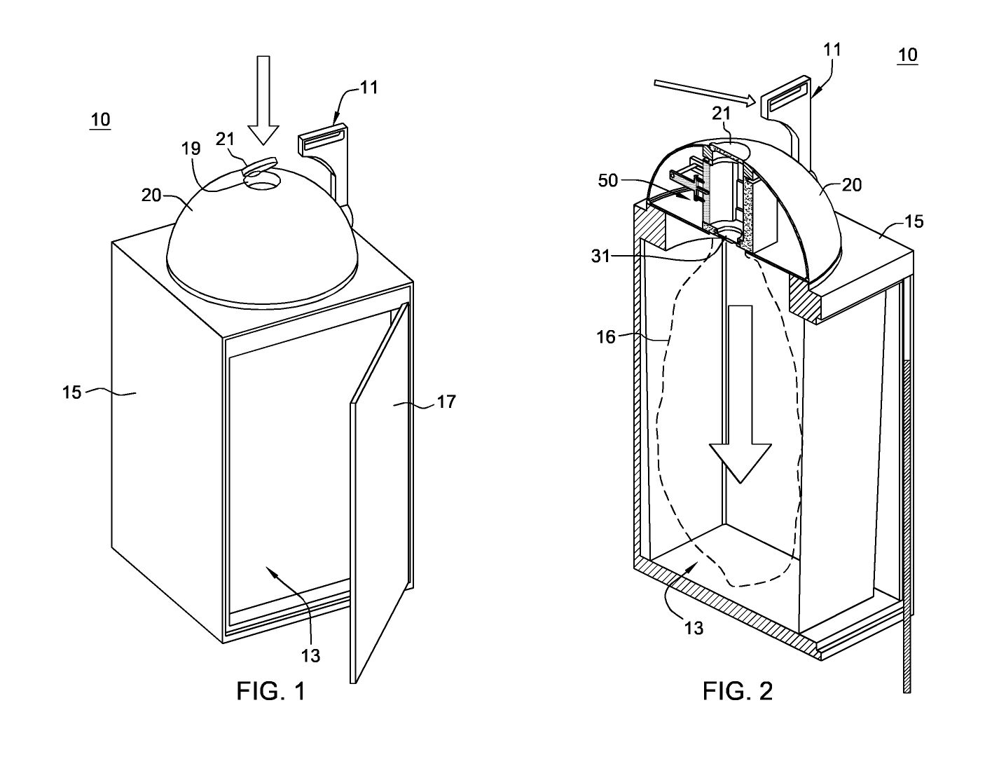

FIG. 1 depicts a diagram of the manually operated recycling bin 10 with mechanism for compacting individual containers according to one embodiment. The recycling bin 10 is an all in one compacting and storage system for aluminum and plastic beverage containers which compacts containers individually whose operation requires only the kinetic energy furnished by the user in utilizing said compactor. As shown in FIG. 1, the recycling bin 10 includes a main housing or receptacle 15 and a top housing 20 in which a recyclable item is loaded into via a hole, slot or receptacle opening 19. Within housing 20 is a compactor mechanism for recyclable item compaction. The main housing receptacle 15 includes an interior 13 for temporarily storing compacted recyclable items and liquids from the compactor 20 and which may be collected in a plastic bag or like flexible receptacles (not shown). A housing door 17 is provided to provide access to the receptacle housing for easy removal and emptying of compacted recyclables from the recycling bin 10. As referred to herein, recyclable items may include but are not limited to: beverage containers, e.g., plastic bottles, or aluminum cans, which may be closed and/or sealed with fluid containment, or open/unsealed.

FIG. 2 depicts an exposed, cut-away view of the recycling bin 10 and showing an exposed interior 13 of the main housing receptacle 10 and compactor housing 20 and compactor mechanism 50. As shown in FIG. 1 and FIG. 2, top housing 20 includes a top trap door 21 which is a safety component that is actuated to close to prevent unwanted items from being placed into the compactor top housing 20, e.g., when compacting a recyclable item. A second trap door 31 is provided at a bottom opening of the top housing 20 in alignment with the top trap door 21 which functions to support a loaded recyclable item prior to and during compaction. After compaction, the second trap door 31 is activated, such as by release of a spring loaded hinge (not shown), to release the compacted item in the direction as shown by the arrow into the interior 13 of the main housing receptacle 15 for temporary storage thereat. In one embodiment, the interior includes a receptacle 16, e.g., a storage container such as a bag, for storing the compacted recyclable containers or items.

In each of the embodiments described herein, a manually operated pull lever mechanism 11 responds to human manipulation to actuate the compactor 50 and create a force for the compactor 50 to compact a recyclable item received in the receptacle opening 19. The handle 11 itself is connected as a network of rigid links and joints (to facilitate sliding an translation movement) in the compactor 50 that transforms a given input force applied to the lever 11 into a desired output force, at a mechanical advantage sufficient to initiate compaction of the recyclable item placed within a housing compacting chamber. For example, manipulating handle 11 in the direction of the arrow shown in FIG. 2, will actuate the compactor 50 to compact a recyclable item. In one embodiment, the bin compactor mechanism 50 provides for a minimum of about 200N of force which is feasible with a mechanical advantage of about 4-5 to crush a beverage container, however other designs may achieve other forces on the order of 1 kN-5 kN forces.

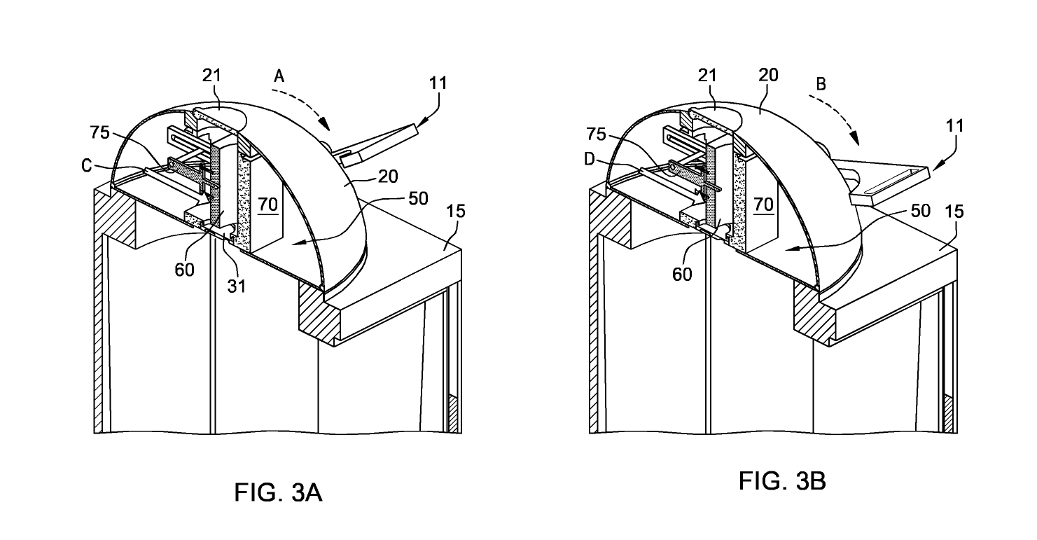

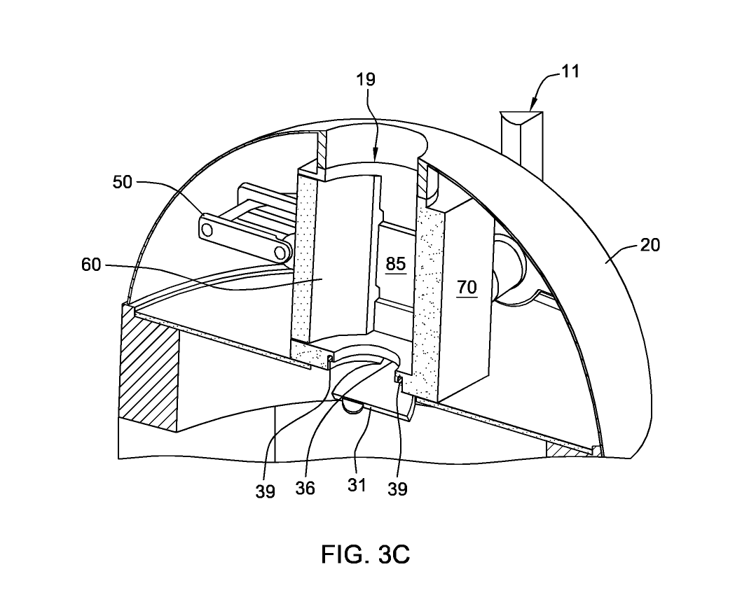

FIGS. 3A and 3B show a more detailed exposed cut-away view of the top housing portion 20 and a state of the compacting mechanism 50 during a manual compacting operation of a recyclable item (not shown) placed within housing 20 via top trap door 21. As shown in FIG. 3A, a recyclable item that is loaded into top housing 20 via door 21 is initially supported by bottom trap door 31 that is initially in a closed position after top loading of the item in the housing 20, and is further situated between two compacting blocks or jaws: a movable block or piston (jaw) 60 and a fixed block (jaw) 70. The moveable block or jaw 60 may comprise a metal piston, a slide or a plunger, or like structure adapted to compress or compact the container against the fixed surface of block 70 within the chamber. An initial manipulation (e.g., a rotation) of pull lever 11, e.g., pulled downward in a rotating direction shown as arrow indicating a first position a “A” with respect to the housing 20 as shown in FIG. 3A, responsively initiates actuation of the movable compacting block 60 in the direction indicated by arrow “C” towards the fixed compacting block 70. At this state of compaction, the movable compacting block 60 has moved in a position toward the fixed block 70 to create a compressive force against the recyclable item that is situated therebetween (not shown).

In one embodiment, the compactor mechanism 50 includes a self-retracting puncture pin mechanism 75 that is configured as an operable part of the movable block 60 and independently movable therewith to facilitate the compacting of the sealed containers. The pin mechanism 75 is a retractable puncture pin that is resistance actuated and configured to extend during compacting to puncture sealed containers that resist compaction, e.g., due to having trapped gas or liquid contents. For example, as shown in FIG. 3A, in the compacting state of compactor mechanism 50, the retractable puncture pin mechanism 75 includes a pin in an initial retracted position that would be insufficient for contacting and puncturing a sealed recyclable container. The linkages connecting the retractable pin mechanism 75 to the lever 11 are configured to extend the puncture pin beyond compacting surface of wall 60 with a mechanical advantage to impart a force that would permit puncturing of a recyclable item between the compacting walls 60 and 70 thereby reducing the force required to compact containers.

That is, as shown in FIG. 3B, a further subsequent motion of pull lever 11, e.g., pulled downward in the rotating direction to a second position shown as position “B” with respect to the housing 20 as shown in FIG. 3B, responsively initiates actuation of the retractable puncture pin mechanism 75 in the same direction indicated as arrow “D” such that the puncture pin extends forward and the compacting surface of the movable wall 60 with a force sufficient for contacting and puncturing a sealed or closed recyclable container situated between the walls 60,70.

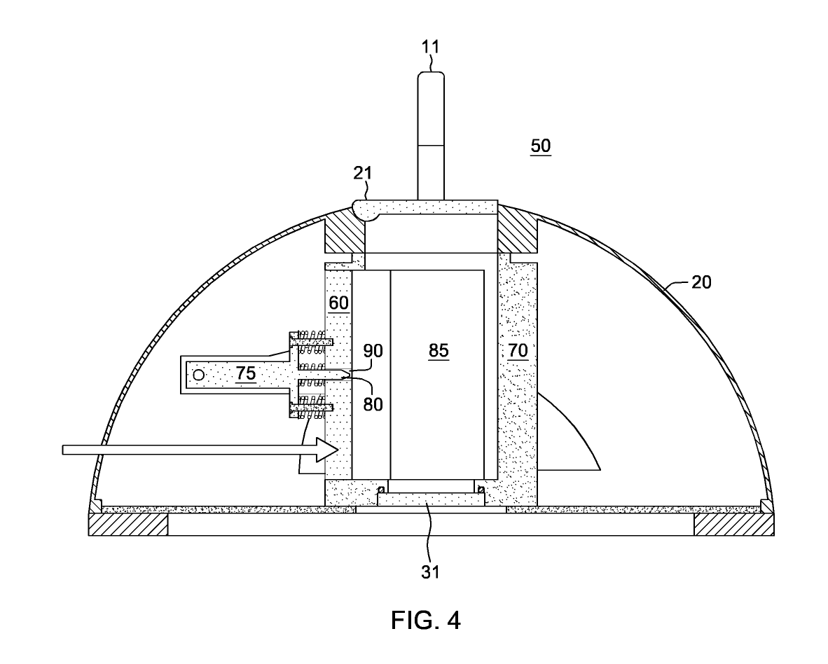

FIG. 4 shows a detailed cutaway view of the compacting mechanism or apparatus 50 located in top compacting portion 20 of the recycling bin 10 in one embodiment. The compacting mechanism 50 includes the first movable compaction block 60 operatively configured with sufficient connection linkages (now shown) to facilitate movement of the wall 60 in the direction of the arrow towards fixed compaction wall 70 responsive to movement of pull lever 11. FIG. 4 in the cutaway view depicted, shows a detailed side view of the movable compaction wall 60 and puncture pin mechanism 75 that is attached to the compacting wall 60 for movement therewith. As further shown, puncture pin mechanism 75 includes a retractable puncture pin 80.

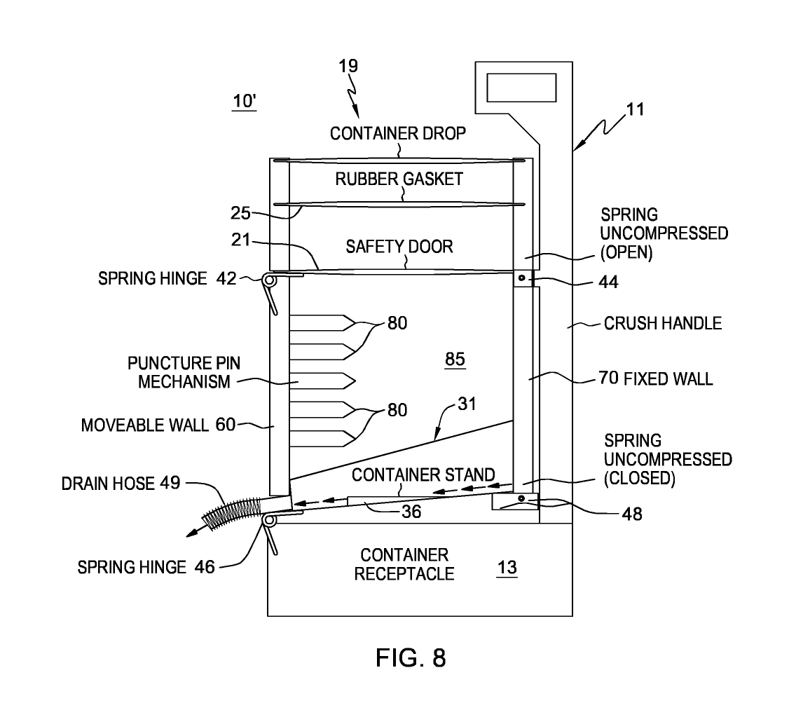

While only a single retractable pin 80 is shown as part of the puncture pin mechanism 75, as shown in FIG. 8, it is understood that puncture pin mechanism 75 may include a plurality of retractable puncture pins 80 located for retractable movement within respective apertures formed along the entire length of the movable compacting wall 60 that move in unison responsive to the pulling of lever 11.

In the position of the pull lever 11 as shown in FIG. 4, the wall 60 is in a retracted position to facilitate the placement of a recyclable item within a compaction chamber 85 formed between the movable wall 60, the fixed wall 70 and second (bottom) trap door 31. In this state, the lever 11 is at an initial position (e.g., upright with respect to housing 20) and the wall 60 and puncture pin mechanism 75 are in a fully retracted position to enable placement of a recyclable item (not shown) in the chamber 85 via top trap door 21 covering opening 19. As shown, the moveable compacting wall 60 includes a through-opening or aperture 90 that accommodates extendable and retractable movement of the puncture pin (or pins) 80 with respect to the wall 60 in the manner as described.

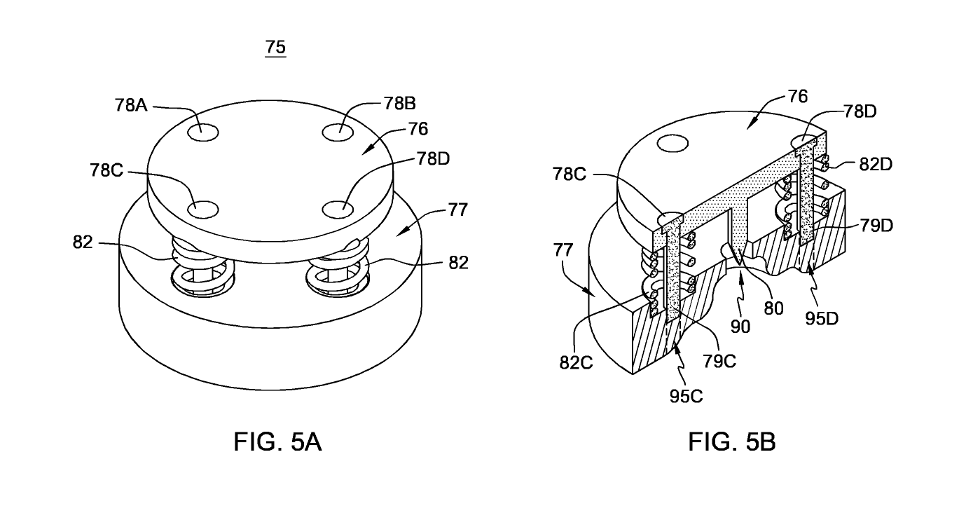

FIG. 5A shows further detail of a puncture pin mechanism 75 and FIG. 5B shows a cut-away exposed view of the puncture pin mechanism 75 in one embodiment. In FIGS. 5A and 5B, the puncture pin mechanism 75 includes a top movable component 76 and a bottom fixed component 77. The bottom fixed component 77 is mounted on and/or coplanar with the movable wall 60 of the compactor mechanism 50. In an embodiment, the top component 76 is movable relative to the fixed component 77 and wall 60. In one embodiment, the bottom component 77 is formed as part of the movable compacting wall 60 and includes at least an aperture or orifice 90 that facilitates additional extending/retracting movement of the puncture pin 80 relative to the component 77 or wall 60. The bottom component is mounted such that the puncture pin 80 itself is aligned with the aperture 90 internally formed within wall 60.

Formed integrally with or attached to the top movable component 76 is the puncture pin 80 of dimension suitable for puncturing a plastic, glass or aluminum container. Puncture pin 80 extends to release pressure due to trapped air and liquids from sealed containers making compaction easier. In one embodiment, puncture pin 80 only extends when the applied crushing force exceeds a certain value, and retracts once force is removed allowing containers to drop freely without jamming. The top component 76 further includes multiple depending pins, e.g., pins 78A, 78B, 78C and 78D, that may be connected to the top component 76 at each respective pin top thereof. Each pin 78A, 78B, 78C and 78D includes a respective pin stem that depend downward to extend partially within a respective aperture formed in the fixed component 77 for extendable movement therein. For example, as shown in FIG. 5B, pins 78C and 78D include respective pin stems 79C and 79D that depend downward to extend partially within a respective apertures 95C and 95D formed in the fixed bottom component 77.

Surrounding each respective pin stem is a respective spring element 82 that may be connected to the top component 76 and bottom component 77 or at each end thereof and initially fix the distance between the top component 76 and bottom component 77 when top portion 76 and pin 80 are in a retracted position according to a position of lever 11. FIG. 5B shows springs 82C and 82D surrounding respective pin stems 79C and 79D between the top and bottom components 76, 77. In one embodiment, each spring element 82 may be a coil spring or helical spring, e.g., design for compression and tension.

In an example operation, when the lever 11 is in an upright position and not being pulled by a human, the top component 76 is in a default uncompressed state relative to the bottom component such that the puncture pin 80 is in a retracted position and the pins, e.g., stems 79C and 79D are in retracted positions within respective apertures 95C, 95D formed in the bottom component 77.

When the recycling bin pull lever 11 is pulled by a human, e.g., in the rotating manner toward a first position shown as “A” in FIG. 3A, due to the mechanical advantage created by linkages that force the movable wall 60 toward the fixed wall 70, a translational force is applied to move that moves inner compacting wall 60 and puncture pin mechanism 75 toward the recyclable item placed within chamber 85. Initially, the compressive force presented by applied movable wall 60 against the container may be sufficient to compact and compress the recyclable item placed within the compaction chamber 85.

In a scenario of a recyclable item being a sealed beverage container, or a closed container having fluid contents, the item may be more difficult to compress. Thus, in addition to the compacting force applied to compact the recyclable item placed in chamber 85, the lever 11 may be further pulled down, e.g., to a position shown as “B” in FIG. 3B, which creates additional linkage force to further extend the puncture pin (or pins) 80 directly through the wall or surface of the recyclable container within the chamber 85 thereby relieving the pressure due to the fluid contents within the sealed container.

In particular, the additional force applied by further pulling of lever 11 pushes the top component 76 of the puncture pin mechanism 75 including plurality of spring loaded pins 78A, 78B, 78C and 78D in fixed connection with the top portion 76 and puncture pin (pins) 80 toward the beverage container through their corresponding aligned apertures within the wall 60 or fixed bottom component 77. In an embodiment, the puncture pin (or pins) 80 may be longer than the pins 78A-78D and/or extend further through the movable wall 60 to pierce or puncture the surface of the container in the chamber 85 as shown in FIG. 3B. The puncture pin 80 is configured to extend through aperture 90 with a force sufficient to pierce a surface or skin of the closed beverage container thereby relieving any pressure that prevents compacting. Several puncture pins 80 may be positioned and configured to be extended through respective apertures in the movable wall which may pierce or puncture a surface of the recyclable beverage container at several locations.

Referring to FIG. 3C, after the recyclable item is punctured using pin mechanism, and the lever 11 is manipulated to an end of its stroke/movement, the trap door 31 at the bottom of the crush chamber 85 is actuated to a released (open) state on the action of spring loaded hinge 36, thereby dropping the compacted or punctured container under force of gravity into the receptacle 16 within the housing 15 after the liquid has drained off. The spring loaded trap door 31 returns to its initial closed state for a next crushing cycle. In further view of FIG. 3C it is the case that once handle/lever 11 is returned to start position, the safety trap doors 21, 31 re-seal against o-ring sealing receptacle from environment. FIG. 3C shows a sealing o-ring element(s) 39 surrounding the bottom trap door to create a seal so odors will not escape from the bottom housing 15.

Further, the pin(s) 80 retract once the force is removed allowing bottles to drop freely without jamming. That is, once the compacting has been completed, the top component 76 of the puncture pin mechanism 75 returns by spring loaded force to its initial non-compacting and non-puncturing initial state. That is, after removing the force enabling puncture of the recyclable container, each respective spring element 82 surrounding each respective pin stem returns to their initial expanded state thereby retracting the top component 76 including the pins 78A, 78B, 78C and 78D and the puncture pin(s) 80 to their initial (non-compacting) position.

In the case of a sealed or closed beverage container having fluid contents being punctured to relieve it contents, recycling bin 10 is provisioned with a liquid capture system for improved cleanliness.

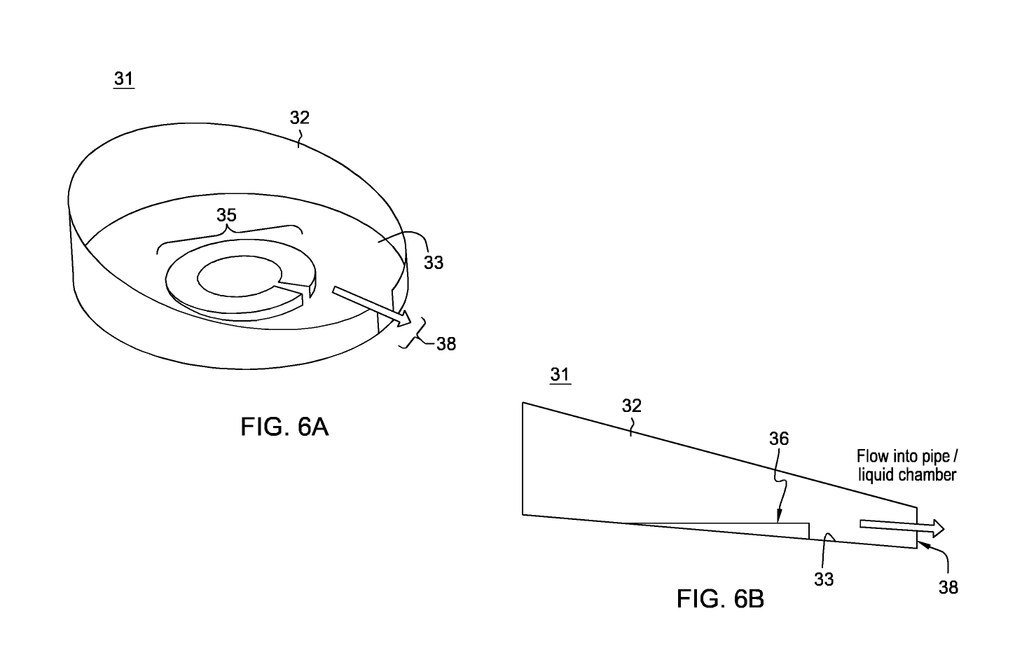

FIG. 6A, in particular, shows one embodiment of the bottom or second trap door 31 that forms the bottom surface of the compactor chamber 85 within in which the recyclable item is received. As shown, the bottom trap door 31 includes a surface 33 and includes a raised peripheral edge or wall 32 providing an integrated funnel into the base of the chamber 85 to aid in containing and collecting of liquid contents that may escape from items when being compacted. In one embodiment, on surface 33 there is provided a circular stand or platform 35 upon which a recyclable item is situated during compaction. In this embodiment, the top surface 33 is sloped downward at an angle relative to a surface of the stand 35 to assist in drainage of any liquids escaped from the compacted recyclable item into a separate serviceable receptacle (not shown). In one embodiment, the liquid capture spring loaded door self-returns to its initial state for the next compacting cycle.

FIG. 6B depicts a side view of the trap door 31 of FIG. 6A, and particularly shows the stand 35 as comprising a single or multiple raised elements that provides a level or horizontal surface 36 upon which a recyclable item is situated suitably when being compacted. The top surface 33 of the door 31 is sloped at an angle with respect to surface 36 so assist drainage whereby any liquid or fluid contents caused by compaction or item puncture can drain by effect of gravity towards an exit conduit egress or egress 38. In one embodiment, the flow of liquid contents may be directed to a fluid container or separate serviceable receptacle (not shown) that collects the liquid. For example, the fluid container may be located inside the housing 13 of the bin 10. Alternatively, or in addition, as shown in FIG. 8, the flow of a liquid contents may be directed to a piping system as shown by arrows in FIG. 8 directed through a drainage hose 49 to remove the liquid contents for collection to another location or receptacle inside the recycling bin and/or in fluid communication with a drainage receptacle outside the recycling bin. The door 31 and any associated piping may be gasket lined to act as an additional layer for odor minimization.

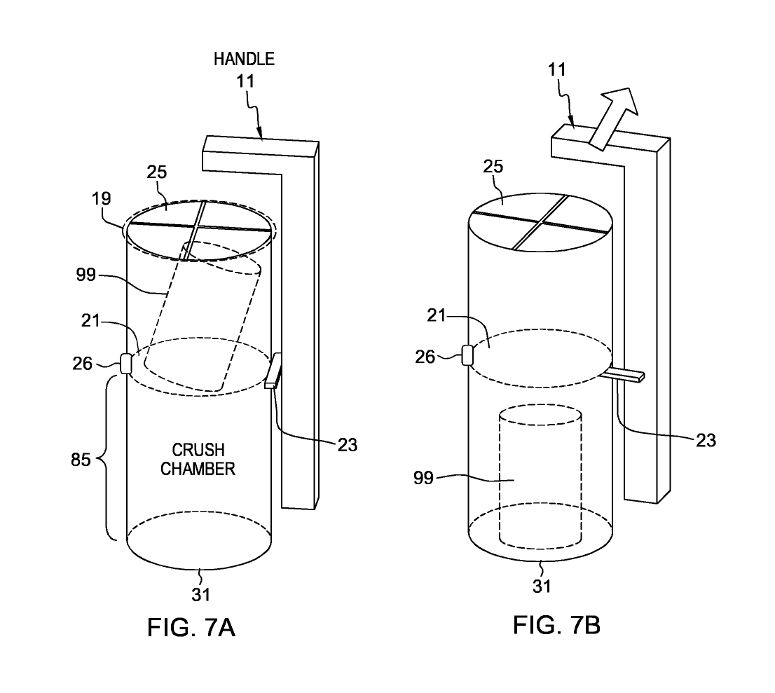

Referring now to FIGS. 7A and 7B, there is conceptually depicted the operations of both safety trap doors 21, 31 in the compacting housing 20 of the embodiment of FIG. 2B. As shown in FIG. 7A, there is located above the first safety trap door 21 a rubber gasket or like flexible element 25 at or near the top opening 19 at the top of the bin 10 that effectively seals the opening during and after compacting to prevent odors and liquids from escaping or being expelled out of the compactor bin. The gasket element 25 is flexible enough to enable recyclable items to be placed in the opening 19 at the top of the recycling bin 10 and return to a sealed state or condition. In one embodiment, prior to compacting, with lever 11 in an initial upright position, the safety doors 21 and 31 are in a closed safety position. For example, as shown in FIG. 7A, an item 99 to be recycled may be placed within the recycle bin 10 through the rubber gasket 25 at opening 19 and the first safety trap door is configured in an open state to let the item 99 fall into the crush chamber. When lever arm/handle 11 is moved to crush (during a compacting stroke), the spring loaded latch 23 retracts and locks the safety door 21, thereby preventing the user to stick in their hands into the crush chamber. In one embodiment, the trap door 21self retracts (opens) on a spring hinge 26 when the recyclable item, e.g., a container 99, is dropped in to the crush chamber 85 where the recyclable item 99 rests in an upright position on the second or bottom trap door 31 that is initially set in a closed position prior to compaction.

In an alternate embodiment, the first safety door can remain closed from force provided by a spring, calibrated such that a user can force a container through the closing once the container is through the door. After depositing the container through the first safety door, the door retracts to a closed position. A lock would be engaged when the lever arm handle is pulled to keep the door in place and prevent hand from entering the chamber.

Then, upon initial actuation, e.g., pulling movement of the handle 11 for compaction, e.g., in the rotating direction pulled for a threshold distance in a direction shown by the arrow in FIG. 7B, operable linkages actuate a spring lock 23 to lock the trap door 21 into a closed position which provides isolation from the compactor 50 and is a safety measure.

In one embodiment, responsive to the hand lever 11 being returned to its top position, the recycling/compacting bin 10 returns to its initial state.

In one embodiment, both safety trap doors 21, 31 are further configured to provide a seal with their respective openings to essentially prevent liquids or odors during and after compacting recyclable items to escape the respective openings. A seal at each top receptacle opening 19 and the bottom opening may be facilitated by a gasket or like rubber seal (not shown) formed at the respective doors 21, 31.

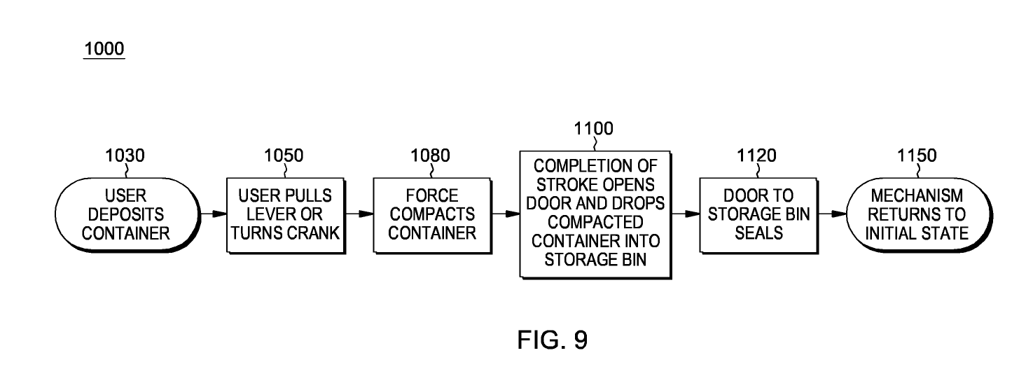

FIG. 9 depicts a usage process flow method 1000 based on the compaction system 10′ depicted in FIG. 8. In FIG. 9, step 1030 depicts a step of receiving a container in the compactor 10′ deposit slot or receptacle opening 19. The container is placed below the opening and further through an odor sealer element such as the rubber gasket element 25. When deposited, the container falls into the crush chamber as first safety door is opened to permit free fall of the container into the chamber, as described herein. As shown in FIG. 8, the first safety door 21 is connected to a first side of the compactor via a spring hinge 42, and a compressed spring mechanism 44 operatively connects the crush lever 11 to the first safety door 21. Initially, spring mechanism 44 is uncompressed when the safety door 21 is closed.

Continuing to 1050, FIG. 9, the lever arm/crank mechanism 11 is then used to provide input to the mechanism, i.e., close the safety door to lock the top safety with the container in the crush chamber 85. In this embodiment, when the safety door is in a closed position after container deposit, the spring 44 is in an uncompressed state. When the crush handle 11 is moved for crushing, e.g., after the container is deposited on top the second safety door 31 at the bottom of the crush chamber 85, the spring mechanism locks the first safety door 21 closed. As shown in FIG. 8, with respect to the second safety trap door 31, this safety door 31 is connected to the first side of the compactor via a spring hinge 46, and a compressed spring mechanism 48 operatively connects the crush lever 11 to the second safety door 31. Initially, spring mechanism 48 is compressed when the safety door 31 is open.

Continuing to 1080, FIG. 9, in the embodiments described herein, the movable wall element, with or without use of the puncture mechanism, is manipulated by the pulling of the crush lever 11 that creates the force to compact the container. That is, at 1080, manipulation of the lever crank 11 will further puncture sealed containers by use of pin(s) 80 in order to reduce force required if the deposited container happens to be sealed with contents.

Once compacted, the second safety door 31 is opened, allowing the container to be dropped into the interior sealed collection bin. That is, at 1100, FIG. 9, completion of the lever stroke opens the second trap door 31 in order to drop the compacted container into a storage bin (not shown). Referring back to FIG. 8, only when the crush handle 11 has reached an end of a crushing stroke, will another rod element (not shown) be actuated to force the second spring mechanism 48 open to allow for the container to fall into the interior 13 of the receptacle. As depicted at 1120, FIG. 9, after opening, the provision of safety hinge 46 ensures that the second safety trap door 31 returns to its closed/engaged configuration system to seal off the storage bin at the interior 13 of the main housing receptacle 15 and minimize odors. Thus, at 1150, the crush lever 11 and spring mechanisms 44 and 48 each return to their initial state.

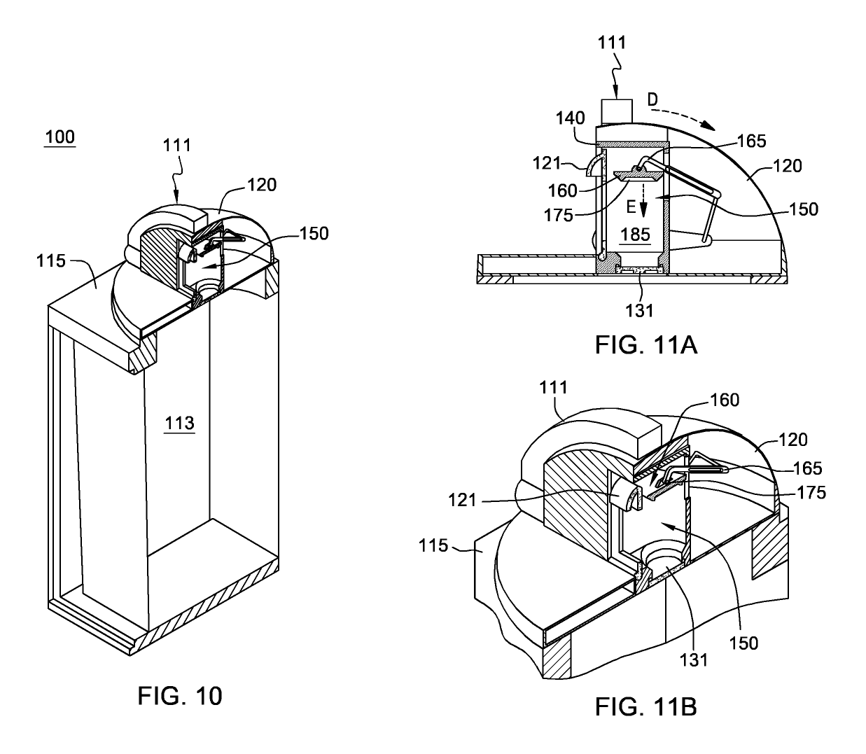

FIG. 10 shows a manually operated recycling bin 100 with mechanism for compacting individual containers that only requires power from user input according to a further embodiment. As shown in FIG. 10, the recycling bin 100 includes a receptacle housing 115 and a top housing portion 120 in which a recyclable item is loaded into via a slot or receptacle opening through a door (not shown) on the front of the housing 120. Within housing 120 is the compactor mechanism 150 for recyclable item compaction. The main housing receptacle 115 includes an interior 113 for temporarily storing compacted recyclable items and liquids from the compactor 100 and which may be collected in a plastic bag or like flexible receptacles as in the embodiment of FIG. 1. A housing door (not shown) is provided to provide access to the receptacle housing for easy removal and emptying of compacted recyclables from the recycling bin 100.

FIGS. 11A and 11B each depict a cut-away view of top portion 120 of the recycling bin 100 showing in compactor housing 120 a compactor mechanism 150. In this embodiment, the compacting mechanism 150 is configured to crush a container axially from the top instead of sideways. Thus, in this embodiment, the can/bottle/container is placed from the sides or the front (instead of the top).

In the exposed views of FIG. 11A and FIG. 11B, top housing 120 includes a safety door/seal element 121 that permits the container to be loaded from the sides or the front. As in the prior embodiment, safety door/seal element 121 is configured to prevent and seal odors from escaping the receptacle. In one embodiment, the safety door/seal element 121 is a door with a gasket, and is locked in place in a closed state when the compacting mechanism 150 is manually actuated to crush a container thereby preventing unwanted items from being placed into the compactor housing 120, e.g., when compacting a recyclable item. A second trap door 131 is provided at a bottom opening of the top housing 120 which functions to support a loaded recyclable item prior to and during compaction. After compaction, the safety trap door 131 is activated, such as by release of a spring loaded hinge (not shown), to release the compacted item into the interior 113 of the main housing receptacle 115 for temporary storage thereat.

In the exposed, cut-away views of FIGS. 11A and 11B a state of the compacting mechanism 150 is shown. For a manual compacting operation, a recyclable item (not shown) is placed within housing 120 via side or front trap door 121. As shown in FIGS. 11A and 11B, a recyclable item that is loaded into top housing 120 via safety door 121 is initially supported by bottom trap door 131 that is initially in a closed position after loading of the container item in the housing 120. In one embodiment, a compaction chamber 185 is provided within a space defined by wall structure 140 and the bottom trap door 131. Situated above the chamber 185 and for reciprocating movement within the chamber is a movable block or piston 160. The moveable block 160 may comprise a piston, a slide or a plunger, or like structure adapted to axially compress or compact the container against the fixed bottom surface (trap door 131) within the chamber.

An initial manipulation (e.g., a rotation) of pull lever 111, e.g., pulled in a downward direction shown by an arrow “D” with respect to the housing 120 as shown in FIG. 11A, responsively initiates actuation of the movable compacting block 160 in the direction indicated by arrow “E” towards the bottom trap door 131.

In one embodiment, the crush lever or handle 111 used to operate the system provides the force required for compaction. In the embodiment shown, the crush handle 111 is stylized and contoured to use a minimal amount of space. As in the prior embodiment, for compaction, the compacting block 160 moves in a position toward the bottom trap door 131 to create a compressive force against the recyclable item from the top that is situated in the chamber.

In the embodiment of FIG. 11B, pull lever mechanism 111 responds to human manipulation to actuate the compactor 150 and create a force for the compacting block 160 to compact a recyclable item received in the chamber. The handle 111 itself is connected as a network of rigid links and joints 165 (to facilitate top-down axial movement) in the compactor 150 that transforms a given input force applied to the lever 111 into a desired output force, at a mechanical advantage sufficient to initiate compaction of the recyclable item placed within a housing compacting chamber. For example, manipulating handle 111 in the direction of the arrow shown in FIG. 11A, will actuate the compactor 150 to compact a recyclable item.

In the embodiment of FIGS. 11A and 11B, the compactor mechanism 50 includes the self-retracting puncture pin mechanism 175 to facilitate the compacting of the sealed containers. Alternatively, or in addition, the puncture pin mechanism 175 may be located at the door 121. Thus, as described in FIG. 10, a method of operating the receptacle 100 in the second embodiment includes: receiving a beverage container that is placed inside chamber 185 of the compacting system through a sealable door 121; engaging crush handle/lever 111 to cause piston 160 to crush/compress container; detecting a resistance to the compression which causes the puncture mechanism 175 to puncture the container to thereby release air pressure in sealed containers; and opening the safety trap door 131 at the bottom of the chamber at an end of handle/lever stroke/movement such that the compacted container is allowed to fall under the force of gravity into a collection receptacle (not shown). Once the crush handle/lever 111 is returned to start position, the doors reseal against o-ring sealing elements to seal off and minimize odors in the receptacle from its environment.

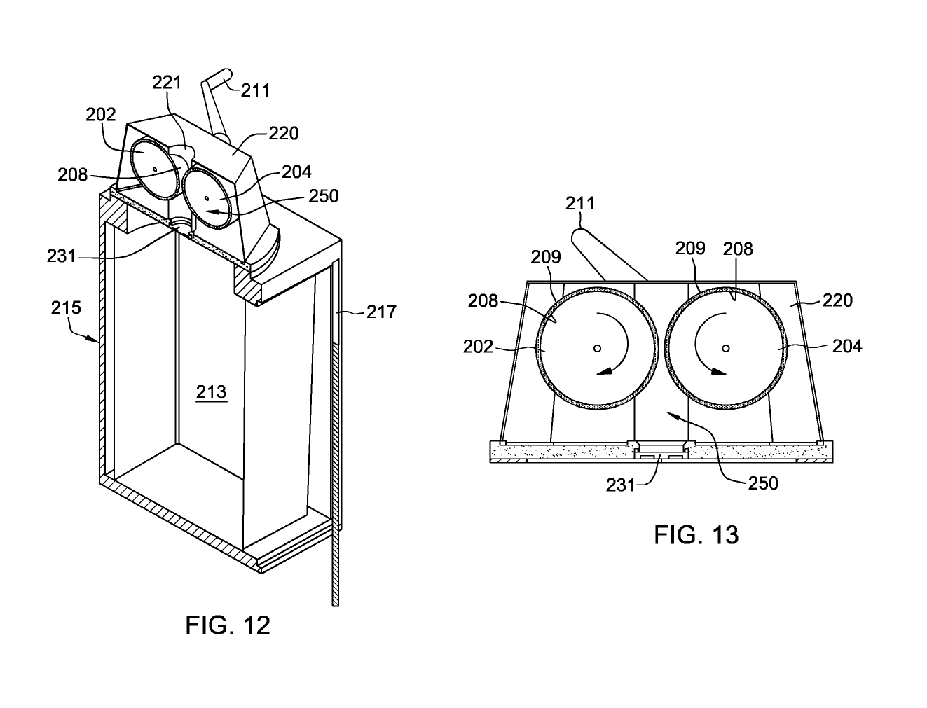

FIG. 12 shows an exposed view of a further alternate embodiment of a manually operated beverage container compacting and storage system (recycling bin) 200 with mechanism for compacting individual containers that only requires power from user input. As shown in FIG. 12, the recycling bin 200 includes a receptacle housing 215 and a top housing portion 220 in which a recyclable item is loaded into via a slot or receptacle opening through a door (not shown) on the front of the housing 220. Within housing 220 is the compactor mechanism 250 for recyclable item compaction. The main housing receptacle 215 includes an interior 213 for temporarily storing compacted recyclable items and liquids from the compactor 200 and which may be collected in a plastic bag or like flexible receptacles as in the embodiment of FIG. 1. A housing door 217 is provided to provide access to the receptacle housing for easy removal and emptying of compacted recyclables from the recycling bin 200.

FIG. 13 depicts a cut-away view of top portion 220 of the recycling bin 200 showing in compactor housing 220 a compactor mechanism 250. In this embodiment, the compacting mechanism 250 is configured to crush a container using compression force of two rotating drums 202, 204 closely spaced apart and operatively responsive to rotational movement of the crush lever or crank arm 211. In the embodiment of FIGS. 12 and 13, top housing 220 includes a slot or opening 221 via which a container item may be deposited for compacting. When deposited, the container to be compacted rests on the periphery of the two drums 202, 204. The crank arm 211 is operatively connected to each drum 202, 204 to simultaneously rotate each drum in response to manually imparted cranking motion. In one embodiment, rotating the lever 211 causes first rotating drum 202 to rotate in a first direction (e.g., shown as clockwise arrow) and the second rotating drum 204 to simultaneously rotate in an opposed direction (e.g., shown as counter-clockwise arrow). Each drum 202, 204 has a peripheral edge 209 thereof lined with a material 208 to facilitate frictional engagement of the deposited container when the crank arm 211 is rotated. That is, engagement with the container to be compacted is ensured by coating the drums with a high friction material, designing the surface to incorporate a series of sharp pins which could both puncture and mechanical engage containers, or some combination thereof. Once rotational movement is imparted, the drums 202, 204 crush the beverage container engaged thereby, thereby effecting a space reduction of a beverage container. That is, the rotating motion of the drums 202, 204 draws container further downwards crushing it between drums. The rotation of drums further causes a trap door 231 at the bottom of the top housing portion 220 to open such that the crushed beverage container drops under force of gravity into the receptacle 213. The door 217 at the main housing 215 of the compacting system 200 reseal, thereby isolating the receptacle from the environment, and preventing escape of odors.

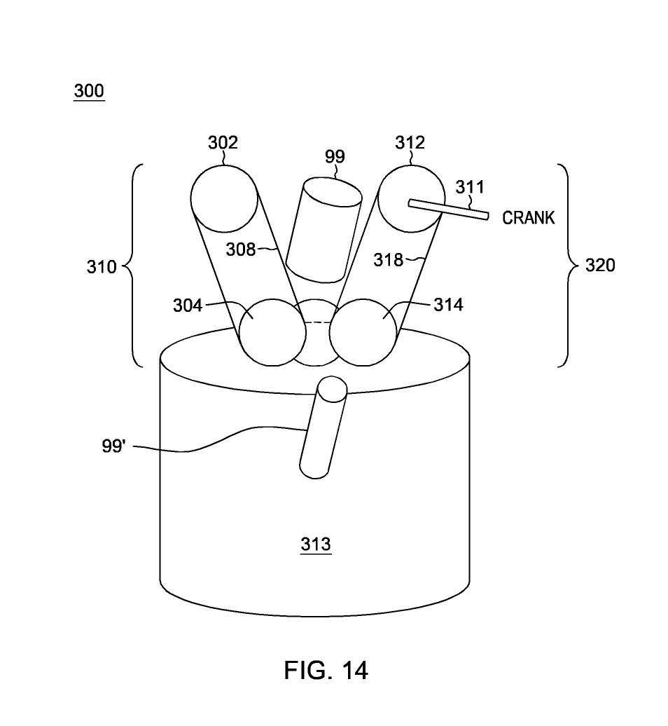

In a further alternate embodiment shown conceptually in FIG. 14, a top portion of a container recycling receptacle housing (not shown) provides a multi-rotatable drum/crank system 300 for compacting a recyclable container. This embodiment is useful for compacting larger containers, e.g., 1 gallon water jugs or large soda bottles, which could be useful at locations such as campsites or picnic areas where larger groups may gather. In the embodiment depicted in FIG. 14, compaction system 300 includes a first dual rotatable drum mechanism 310 including rotatable drums 302, 304 that are operatively connected for rotational motion using a belt 308 wound about the periphery of each drum, and includes a second dual rotatable drum mechanism 320 including rotatable drums 312, 314 that are operatively connected for rotational motion using a belt 318 wound about a periphery of each drum. Each dual rotatable drum mechanism 310 and 320 is belt driven responsive to manual rotation of crank arm 311. In one embodiment, when deposited, the container 99 to be compacted is engaged by the periphery of the two drums 304, 314. The crank arm 311 is operatively connected to each drum 302, 312 to simultaneously rotate each drum in response to manually imparted cranking motion. In one embodiment, rotating the lever 311 causes first rotating drum 302 to rotate in a first direction and the second rotating drum 312 to simultaneously rotate in an opposed direction. Belts 308 and 318 engaging the rotating drums cause respective drums 304, 314 to rotate in opposed direction. Each drum 304, 314 has a peripheral edge thereof lined with a material to facilitate frictional engagement of the deposited container 99 when the crank arm 311 is rotated. Once rotational movement is imparted, the drums 304, 314 crush the beverage container engaged thereby, thereby effecting a space reduction of a beverage container. That is, the rotating motion of the drums 304, 314 draws container further downwards crushing it between drums. The rotation of drums further causes a trap door (not shown) at the bottom of the top housing portion to open such that the crushed beverage container 99′ drops under force of gravity into a receptacle 313.

While various embodiments are described herein, it will be appreciated from the specification that various combinations of elements, variations or improvements therein may be made by those skilled in the art, and are within the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for compacting and storage of containers comprising:
a housing providing an enclosure;
a compacting compartment located in said housing above said enclosure and having an opening for receiving a container to be compacted, the compacting compartment having:
a first retractable hinged trap door beneath the opening and in an initial open position to receive the container into a compaction chamber, said first hinged trap door mechanically linked to a lever arm and configured in a closed position in response to said lever arm being manually manipulated during compacting in response to a lever arm compacting stroke, and said first trap door retracting to a closed position during said compacting; and
a second hinged trap door in vertical alignment and beneath with the first trap door and in an initial closed position to provide a bottom surface of the compacting chamber for supporting said container received therein, said second trap door further mechanically linked to said lever arm and in the closed position while said lever arm is manually manipulated for said compacting responsive to a lever arm compacting stroke; and
a first compacting element providing a fixed compacting surface of said compacting chamber; and
a second compacting element having a compacting surface, said second compacting element further mechanically linked to the lever arm with a mechanical linkage configured to move the second compacting element toward the first compacting element with a compacting force for compressing the container supported in the compacting chamber against the fixed compacting element in response to said lever arm being manually manipulated for compacting.

2. The apparatus as claimed in claim 1, further comprising:
a puncture support means mounted on a non-compacting surface of said second compacting element for puncturing a wall or surface of said container within said compacting chamber during said compressing.

3. The apparatus as claimed in claim 2, wherein said puncture support means comprises:
a self-retractable top portion;
a base portion fixedly connected to or forming part of a non-contacting surface of said second compacting element, and
a further mechanical linkage connecting said self-retractable top portion to said lever arm and adapted to extend said self-retracting top portion toward and self-retract from said base portion in response to said manipulation of said lever arm during said compacting,
said self-retracting top portion having a puncture tip structure for puncturing said container supported in said chamber when said top portion is extended,
wherein said further mechanical linkage is resistance actuated to provide extending of said self-retracting top portion at a mechanical advantage sufficient to impart a force enabling said puncture tip structure to puncture a wall or surface material of said container in said compacting chamber.

4. The apparatus as claimed in claim 3, further comprising:
an opening formed in said base portion and aligned with the puncture tip portion to permit extending and retracting movement of said puncture tip portion therethrough; and
an aperture in said second compacting element in alignment with said opening in said base portion, said aperture dimensioned to permit extending and retracting movement of said puncture tip portion through said aperture during said compacting.

5. The apparatus as claimed in claim 3, wherein said puncture support element further comprises:
a plurality of compression springs having respective ends fixed to and separating said top portion and base portion at multiple locations;
a plurality of corresponding pins having a first end fixed to said top portion and depending from said top portion, a respective pin extending through a corresponding compression spring and each having a second end situated in said base portion for extended and retracting movement through a respective aligned opening formed in said base portion, wherein said top portion, puncture tip portion, and plurality of pins extend towards the base portion thereby compressing said springs in response to said manipulation of said lever arm to said third position, and retracting by de-compressing said springs after puncturing said container.

6. The apparatus as claimed in claim 3, further comprising: additional mechanical linkage connecting said lever arm to said second hinged trap door, said additional mechanical linkage responding to said lever arm movement at an end of the lever arm compacting stroke by releasing said second hinged trap door to an open condition to expel the compacted container from the compaction chamber to a first receptacle within said enclosure.

7. The apparatus as claimed in claim 6, wherein a liquid content from a container escapes said container when punctured and/or compressed in said compaction chamber, said apparatus further comprising:
a collection well formed on said top surface of said second trap door, said collection will comprising a surrounding wall structure formed along a periphery of said top surface defining a well with said top surface for containing any liquid content expelled from said container.

8. The apparatus as claimed in claim 7, wherein said second trap door surface is sloped in a direction to drain escaped liquids to an opening formed at said surrounding wall; and
a means for conveying escaped liquid content from said opening to a second receptacle within said enclosure.

9. The apparatus as claimed in claim 8, further comprising:
formed on said second trap door surface, a raised structure having a level surface relative to said sloped surface, said level surface dimensioned to support said received container deposited therein for compacting and/or puncturing.

10. The apparatus as claimed in claim 8, wherein said conveying means comprises a flexible piping, hose, or conduit structure configured to drain said second receptacle located within said enclosure.

11. The apparatus as claimed in claim 1, wherein each said first and second trap doors comprise:
a gasket seal element in cooperative arrangement with a periphery of respective first and second trap doors at each respective openings and adapted to minimize a release of odors from said containers in said receptacle and compacting chamber.

12. A method for compacting a container in a recycling bin having a housing including a receptacle therein to store compacted container, said method comprising:
receiving, via a deposit opening of said housing, a container to be compacted in said bin, said container dropping into a compaction chamber through a first trap door beneath said deposit opening and in an initial open position;
closing said first trap door in response to a lever arm mechanically linked to said first trap door being manipulated to a position for compacting, wherein said received container is supported on a surface of a second trap door defining a bottom of a compacting chamber, said second trap door further mechanically linked to said lever arm and in a closed state while said lever arm is manually manipulated for said compacting responsive to a lever arm compacting stroke; and
actuating a first compacting element having a compacting surface to move toward a second compacting element providing a fixed compacting surface of said compacting chamber with a compacting force for compressing the container supported in the compacting chamber against the fixed compacting element in response to said lever arm being manually manipulated during said compacting, the first hinged trap door being in the closed position during said lever arm compacting stroke.

13. The method as claimed in claim 12, further comprising:
extending, responsive to the lever arm being manipulated during said compacting, a puncture element with a force configured to puncture a wall or surface of said container supported within said compacting chamber.

14. The method as claimed in claim 13, wherein the extending the puncture element to puncture the container comprises:
actuating, by sensing a resistance to compressing, a further mechanical linkage connecting a self-retractable top portion of said puncture element to said lever arm to extend said self-retracting top portion toward a base portion fixedly connected to or forming part of a non-contacting surface of said second compacting element, said self-retracting top portion having a puncture tip structure for puncturing said container supported in said chamber when said top portion is extended, and
wherein said further mechanical linkage provides extending of said self-retracting top portion at a mechanical advantage sufficient to impart a force enabling said puncture tip structure to puncture a wall or surface material of said container in said compacting chamber.

15. The method as claimed in claim 14, wherein said extending and retracting movement of said puncture tip structure is through:
an opening formed in said base portion and aligned with the puncture tip portion to permit extending and retracting movement of said puncture tip portion therethrough; and
an aperture in said second compacting element in alignment with said opening in said base portion, said aperture dimensioned to permit extending and retracting movement of said puncture tip portion through said aperture during said compressing.

16. The method as claimed in claim 14, wherein said self-retracting top portion comprises a plurality of pins having a first end fixed to said top portion and extending from said top portion, said extending said top portion toward said base portion further comprising:
compressing a plurality of compression springs at multiple locations in response to said manipulation of said lever arm during said compacting, each spring having respective ends fixed to and separating said top portion and base portion at each location;
extending each pin of said plurality of pins through a respective compression spring at each said location, each pin having a second end situated in said base portion for extended and retracting movement through a respective aligned opening formed in said base portion, and
de-compressing said springs to self-retract said top portion after puncturing said container.

17. The method claimed in claim 14, further comprising:
releasing said second hinged trap door to an open condition to expel the compacted container from the compaction chamber to a first receptacle within said enclosure,
said releasing in response to a lever arm mechanically linked to said second trap door being manually manipulated to an end of the lever arm compacting stroke.

18. The method as claimed in claim 17, wherein a liquid content from a container escapes said container when punctured and/or compressed in said compaction chamber, said method further comprising:
containing any liquid content escaping from said container in a collection well formed on said top surface of said second trap door, said collection well comprising a surrounding wall structure formed along a periphery of said top surface defining a well with said top surface.

19. The method as claimed in claim 18, wherein said second trap door surface is sloped in a direction to drain escaped liquids to an opening formed at said surrounding wall, said method comprising:
conveying escaped liquid content from said opening to a second receptacle within said enclosure.

20. The method as claimed in claim 18, further comprising:
supporting said received container deposited in said compacting chamber for compacting and/or puncturing on a raised structure formed on said second trap door surface and having a level surface relative to said sloped surface.
